(19) United States
(12) Patent Application Publication
(10) Pub. No.: US 2012/0297028 A1
(43) Pub. Date: Nov. 22, 2012

(54) INTEGRATED REMOTE POLLUTION MONITORING AND INDEXING SYSTEM AND METHOD THEREOF

(76) Inventors: Pranamesh Das, Noida (IN); Nitin Gupta, Noida (IN)

(21) Appl. No.: 13/574,027

(22) PCT Filed: Jan. 21, 2011
(86) PCT No.: PCT/IN2011/000047

§ 371 Date: Jul. 19, 2012

(30) Foreign Application Priority Data
Jan. 21, 2010 (IN) 113/DEL/2010

(51) Int. Cl. G06F 15/16

(52) U.S. Cl. 709/217

(57) ABSTRACT

The invention relates to a system for integrated remote monitoring and measuring of real time pollution levels together with real time weather details and a method of aggregating, analyzing and indexing the disparate data into a single measurable and accessible real time data for the user. The invention further relates to a method and means of displaying the pollution index of different types of pollution levels of air, water, sewage, noise, radiation, light and soil and weather details in real time through various displaying methods.

### FIELD OF THE INVENTION

This invention relates to a system for integrated remote monitoring and measuring of pollution levels together with other environmental details like, but not limited to, real time weather details or seismic details and a method of aggregating, analysing and indexing the disparate data into a single measurable and accessible pollution and environment index data for the user.

### BACKGROUND OF THE INVENTION

Environmental pollution is a serious problem that is particularly acute in urban areas. Much of this pollution is produced by exhaust emissions from motor vehicles and other combustion engines, effluents and discharges from variety of sources like industries and factories, usage of modern communication tools like mobile phones etc.

Governmental standards have been set for regulating the allowable amounts of certain pollutants from such sources. Additionally, in many geographic areas, periodic inspections are required in order to ensure that concerned entities like motor vehicles, industries and factories meet these standards. The ability to measure pollutants during a realistic operating period, monitoring and indexing is a growing need in light of recent efforts to regulate and decrease the level of various types of pollutions.

At present various sensors are being used to detect the pollutant levels and considered quite reliable component available for the measuring and monitoring of pollutant levels. However, the main problems limiting the development of a successful multiple pollutant sensors (which often comprise many sensors) are: selectivity, sensitivity, stability, reproducibility, response time, detection limitations and cost issues.

Ideally, a sensor should be stable at variety of temperature gradients and should constantly withstand harsh environments, particulate matter, un-burnt hydrocarbons, carbon monoxide, nitrogen, oxygen and water vapour exposures. The sensitivity of such a sensor should also be highly efficient in comparison to other sensors and should ideally demonstrate response and recovery times below one second. However, none of the said standards have been found in any state-of-the-art sensors fulfilling all the requirements at reasonable cost.

Further, the information regarding the pollutant or pollution level in any specific area is not easily accessible and understandable in terms of specific pollution indices by a user at remote end. There is no such specific pollution information system existing today which provides an easily interpretable data, map or graphical user interface for real time pollution gradients or other environmental details in any specific area.

Further the most talked about carbon footprint analogy is only catering to the gaseous pollution while other pollution sources are gravely endangering the habitability of living organisms including humans and are not being dealt with properly.

The state of the art technologies used for pollution monitoring are generally based on statistical approaches and are not as accurate as a real time monitoring system. The present state of the art only provides levels of particulate matters, suspended particulate matters, toxic gases, etc. in environment and lack an auto-mated system to aggregate, analyze and decipher such data from various sources including stationary and mobile sources and represent the same in an easily accessible and readable manner.

The currently available tools and software are not able to, in a cost effective way, integrate air, water, soil, weather, radiation, noise, and biological pollutants to produce a single measurable and accessible pollution index data in real time for the user.

The present technologies are not able to fulfil all the followings objects:
a. A Reliable simultaneous and continuous reading and analyzing of air, water, soil, light, noise, particulate and radiation pollutant content;
b. A considerably low cost (by many times for the given accuracy);
c. Maintaining the accuracy levels as required by the government bodies for ambient as well as process related levels;
d. A considerably small size for extreme mobility and flexibility;
e. Non dependence on standard sources of electricity and fossil fuels. Non availability of usage of solar system in the current system;
f. Non availability of remote data transfer using multitude of means; and
g. Local Sensor network management for communicating with other monitoring devices

Currently, there is no such capable system that aggregates data in a highly scalable manner and analyzes the data from multitude of sources and sensors, including from interfaces of other third party sensors assemblies, to arrive at a single index for ease of understanding for general public. Further, there is a need for such system which provides for standardization as well as expansion of the already established carbon credit related eco system to include a more comprehensive set of data that effects the life of any living system in nature include but not limited to humans, animals, plants and trees and other microorganisms each of which is required to maintain the fine (and correct) balance of life.

### Object of the Invention

The principal object of this invention is to provide a system for remote monitoring and measuring of various pollutant levels in real time.

Another object to this invention is to provide remote monitoring and measuring system for real time environmental details including that of various chemical and biological readings.

A further object of this invention is to integrate various readings of air, water, soil, weather, radiation, noise, and biological pollutants in a single measurable and accessible pollution index data for the user.

A further object of this invention is to provide a reliable continuous reading and analyzing system for air, water, soil, and radiation pollutant contents.

A further object of this invention is to provide an improved system and method for monitoring and measuring various pollutants levels in real time.

A further object of this invention is to provide a low cost real time monitoring and measuring system for various pollutants levels.

A further object of this invention is to provide a portable system for remote monitoring and measuring of various pollutant levels.

A further object of this invention is to provide a plurality of wired or wireless multi-functional contamination sensing units that are capable of measuring and monitoring various pollutants levels.

A further object of this invention is to provide a novel system and method of aggregating, analysing and indexing the disparate data into a single measurable and accessible pollution index for the user.

A further object of this invention is to provide various means of displaying the pollution index as well as the actual detected sensor values of the environment through a webpage.

A further object of this invention is to provide a real time colour map for pollution index displaying on various mediums like on paper, digital screens like that of Televisions, mobile phone screens, web pages, computer terminals etc.

A further objective of this invention is to provide an exhaustive means of notifications by a multitude of methods like, but not limited to, alarm, flashing indicator lamp, sms, mms, email, indications on real-time time reporting application and webpage about any exceedance of the pollution levels in violation of the norms of the region.

A further objective of this invention is to provide a real-time audio, visual as well as printed and recorded proof like that of captured photo or video or recorded video or paper printouts by the device at the point of monitoring, of any exceedance of the pollution levels in violation of the norms of the region.

Still another object of this invention is to provide an improved system and method for real time measuring pollutant levels or environmental details in a quicker and more accurate manner.

### SUMMARY OF THE INVENTION

This invention relates to a system for integrated remote monitoring and measuring of pollution levels together with real time environmental data like weather details and a method of aggregating, analysing and indexing the disparate data into a single measurable and accessible real time pollution index for the user.

More particularly, the invention relates to a novel system and method for measuring a single measurable unit wherein the novel integrated measuring system will interface, wired or wirelessly, with the plurality of different contamination sensing units made up of, but not limiting to, electronic, chemical, electro-chemical, mechanical, electro-mechanical, biological and electro-biological types.

This integrated remote pollution monitoring system is able to measure, aggregate, store and index the disparate data into a single measurable pollution index of different types of pollution levels of air, water, sewage, noise, radiation, light and soil.

The invention further relates to a method wherein the data thus stored in remote web servers will serve as a means of displaying the pollution index as well as the actual, calibration modified or time averaged detected sensor values of the environment through a webpage for a user accessing the web page. Data for such a page will be updated on a continuous basis as and when the data is available from the various sensing nodes.

The invention accordingly comprises several steps and relation of one or more of such steps with respect to each of the others, and the various features of construction, combinations or elements and arrangement of parts which are adapted to effect such steps, all is exemplified in the following detailed disclosure, and the scope of the invention is indicated in the claims.

### BRIEF DESCRIPTION OF THE DRAWINGS

For a complete understanding of this invention, references are made to the following description taken in connection with the accompanying drawings, in which:

FIG. 1 is a complete communication system for remote monitoring and measuring of various air pollutants levels.

FIG. 2 is a complete communication system for remote monitoring and measuring of various water pollutants levels.

FIG. 3 is a graphical representation of real time O₂ level on a specific geographical location.

FIG. 4 is a graphical representation of real time NO₂ level on a specific geographical location.

FIG. 5 is a graphical representation of real time SO₂ level on a specific geographical location.

FIG. 6 is a graphical representation of real time SPM level on a specific geographical location.

### DETAILED DESCRIPTION OF THE INVENTION

The invention relates to a system for integrated remote monitoring and measurement of pollution levels together with other environmental details like real time weather details or seismic details and a method of aggregating, analysing and indexing the disparate data into a single measurable and accessible pollution and environmental index data for the user. This integrated remote pollution monitoring system is able to measure, aggregate, and index the disparate data into a single measurable pollution index of various different kinds of pollution level of air, water, sewage, noise, radiation, light and soil.

In a preferred embodiment of the invention, a system of hardware devices able to collect, store and aggregate, analyze and process data from different pollution sensing units are connected through wired or wireless medium to create a large scientific eco-system that will be able to effectively monitor and assists such other multitude of systems to control, manage and possibly reverse all or some of the ill effects of all or most kinds of pollutions by using the above data. The processing of this data thus aggregated generates a pollution index which directly reflects in the suitability of the environment consisting of air water, soil and space under observation for habitability and harmfulness for any living organism.

In another embodiment of the invention, the data thus collected will be stored in local database comprising of one or more of data storage systems from the group of, but not limited to, RAM, ROM, and all types of Solid State Device, Magnetic Hard Disk, and Magnetic Tape etc. Further, the data collected by the device is also remotely stored in web servers, either as files or as database entries, by any means of uploading the data through data transfer technologies from the group of, but not limited to, FTP, Email, HTTP, AJAX, XML Transfer, TCP/IP, etc.

The invention further relates to a method wherein the data thus stored in remote web servers will serve as a means of displaying the pollution index as well as the actual detected sensor values of the environment through a webpage for a user accessing the web page. Data for such a page will be updated on a continuous basis as and when the data is available from the various sensing nodes.

The display of the pollutants and the index will be shown in various forms to the end user. For example, but not limited to, it will be available in inbuilt LCD screen, TV screens, mobile device screens including those of mobile phones, tablets and notebooks etc, digital hoardings, kiosks, Internet browsers on PC. The display will be generated either directly on the screens using various mechanisms or using display rendering schemes like those inside an application such as a browser or even a standalone application like on mobile phones.

The displayed entity will be instantaneous values of the pollutants and the index and various other forms like, but not limited to, mean average graphs, graphs of instantaneous values, graphs and charts of archived data. The displayed entities will be made user interactive wherever possible, for example interactive charts inside a browser using technologies like, but not limited to, AJAX, Java, Silverlight, adobe flash etc, whereby the user will be able to draw interactive trend lines and be able to store such self accessed information.

In another example of displayed entity, the user can be shown maps of actual pollutant level combined with weather parameters, the trend patterns of the movement of such pollutants. Such maps could even be bound to GoogleMaps for an easy and true representation of the data. Within the GoogleMaps, the user can use given features of zooming into or out of an area so as to make best use of the info generated by the system.

Such information can also be a part of additional info for people like travelers who need real time and accurate weather reporting along with pollution data in the area of interest.

The pollution index as calculated will be utilized by various organizations including but not limited to, government bodies, pollution control institutions, polluting or non-polluting factories, residential buildings, infrastructure units, power generating plants, and any such other entities for various programs to combat the ill effects of all or some of the pollutions.

Government bodies can do accurate soil monitoring and segregate areas for development of cities for land that have shown to be unfit for cultivation. Sensitive areas like animal reserves, hospitals and schools can use the device to maintain and prevent miscreants of violating or exceeding the levels of noise or light pollution as per the required laws of the land. Such governing bodies, authorities or organisations will have a consolidated view of the pollution distribution and then take appropriate actions to either tax any polluting entity or incentivise the polluting units to reduce or remove the generation of pollution.

There will be comprehensive alarm system by means of which tamper of device or excess of the pollution levels will be notified. Apart from the flashing high brightness LED light and built-in audible siren alarm, provision for sending alert on abnormal conditions exists over SMS, Email and other messing protocols. There is also a provision for capturing audio visual information of the possible breach of pollutant levels by way of image or video capturing of the instance of violation and sending it to the concerned supervisory authorities.

The hardware device will be made into, but not limited to, various form factors customized depending on the need. For example there will be different form factors for ambient monitoring and pollution source monitoring. In yet another manifestation, a small form factor could be for home use and hospital use for suitability of such small size. In yet another manifestation, the device could be fitted inside vehicle and a comprehensive monitoring system can be enabled whereby every vehicle running on fossil fuel could monitor their exhaust for the pollutants and broadcast the data over radio frequency and other means to the central server.

The intended installation sites for the disclosed integrated pollution data aggregating devices are a plurality of locations like, but not limited to, factories, industries, institutions, hospitals, schools, civic installations like bus stations, airports, railway stations, residential colonies, parks, traffic crossings, commercial complexes, shopping complexes, mobile towers, power plants, office buildings, gas stations, vehicles, etc.

The disclosed integrated pollution data aggregating devices when installed in and around mobile base stations can optionally broadcast the pollution data to all nearby mobile phones in its vicinity and the pollution status can be shown in the mobile screen of the users connected to that tower in the vicinity. Such an application will be useful for a person to quickly make assessment of the pollution status of the environment as he or she is moving around in the area and taking precautionary measures to minimize the ill effects of any polluting environment that they may be in.

Additionally, simple devices could be made which can interact with such mobile towers or any other mode of area specific transmission systems to show within a premises used by humans like in homes and offices to display the real time pollution status of the environment they are living in. Such pollution index can also be correlated with time representing a pollution index versus time information which will be helpful to deduce cyclic trends in the pollution levels throughout the year. Such pollution indexes will also be utilized by internationally recognized governing bodies to monitor the pollution reduction target of major international agreements like the Kyoto protocol and Copenhagen agreement.

### Method

The indexing method is primarily based on the ill effects on the various natural and manmade system like the following (but not limited to)
a. Health Impact
b. Social Impact
c. Economic Impact
d. Ecological Impact
e. Climate Impact

The impact is calculated in terms of financial outflow that is required to rectify the system back to an acceptable limit such that its relevance is maintained in the current ecosystem.

This indexing system is available for a universally applicable monitoring ecosystem as well as enabling different entities to make use of it for maintaining the required life quality. For example, it could be used to ascertain the level of pollutants generated by an individual person or entity and tax him or her or the entity to such an amount that is equivalent to the cost required to reverse the effects of such pollutants.

The present invention provides a method of continuous emission monitoring system capable of measuring ambient concentration levels or process specific levels of, but not limited to, SO₂, NO₂, CO, CO₂, H₂S, O₂, O₃, Cl₂, NH₃, VOC, PM_{2.5} and PM₁₀ along with the measurement of atmospheric environment monitoring of Temperature, Pressure, Humidity, Wind Direction, Wind Speed and Rain Fall.

The system runs primarily on solar power or a main supply and has an internal Li-Ion battery to provide uninterrupted power supply to the sensors and microprocessor controller. The system has inbuilt memory to store data of all of its measuring parameters for more than a month of continuous data logging. Additionally, it has capabilities of uploading the data into a central server using multiple Radio Frequency Modes of data communication like Wi-Fi and GSM.

The system can effectively communicate wirelessly using a proprietary Mesh Pico Network to other pollution measurement units that can measure water, soil and radiation parameters in real time.

It is further provided that the pollution index will have values ranging between a negative to a positive integer number. A positive pollution index number will indicate a high pollution levels in that environment. A negative pollution index number will indicate a unit or machine or special geographically notified area like special landfills, which are helping in the overall reduction of pollution of the immediate environment or even reduction of pollution from a remote geographical location. A zero in the pollution index will represent a geographical area which is in perfect harmony with nature and most suitable for humans as well as any other live biological system.

The pollution index may further be utilized as a colour coding map superimposed on a geo spatial map to make quick and easy assessment of the effects of the various polluting mediums. Any such colour coding will effectively have two or more extremes represented by two or more colours. For example, the colour green can be used to map geographical maps that have a pollution index of zero and a colour red can be used to map a geographical map that has a high positive pollution index and in between green and red, the various shades of red and green could represent the pollution state of the environment. Similarly a geographical area marked as blue will mark areas with negative pollution index that will represent areas processing the environment for reduction of polluting agents. Such a colour coding map would be representative of a single shot view of a large geographical area and when seen on a daily basis will give the trends of the pollution levels of an area and its expansion or contraction with time. Such a colour coding scheme would be called a pollution map. The colour map would be displayable on various mediums like on paper, digital screens like that of Televisions, mobile phone screens, web pages, computer terminals etc.

The pollution index thus arrived will also be directly linked to the carbon footprint of the geographical area or the environment. An area with a high positive pollution index, represented by bright red colour on the pollution map will have a high carbon foot print thereby indicating the unsuitability of human livelihood of habitability. An area with negative pollution index represented by the blue colour on the pollution map will have negative carbon footprint, thereby also enabling entities responsible for any such pollution reducing activity to earn carbon credits. An area with near zero pollution index represented by a bright green colour on the pollution map will have a near zero carbon foot print, thus representative of a clean environment with a very healthy habitability environment.

The pollution index with very high positive numbers which are representative of highly polluting activity could also be taxed by pollution controlling agencies set up by the governing bodies of the area. Similarly, the pollution map of the area will be utilized by civic authorities of the governing bodies of an area to properly segregate residential and industrial areas for effectively reducing the harmful effects of pollutions and increasing the overall life quality of humans and other living organisms. The pollution map will also be utilized by the civic authorities to perform all kinds of detections of trends on the pollution status of the area and its spread with time and thereafter take appropriate actions to reverse any adverse effects.

The pollution map is also representative of a simple form of data visualization that is easily understood by general public. The easy visual representative of the pollution map can be of vital importance to average human beings as they now don't have to understand the scientific terms of pollutions like “ppm”, “ppb” or concentration or toxicity of various polluting toxic gases. Such representation can be utilized for preventing or taking judicious decisions by average citizens about the health aspects of an area. For example, a person with asthma can utilize this map to regularly check the suitability of his or her stay in a particular area based on the colour of the map.

### Working Sequence

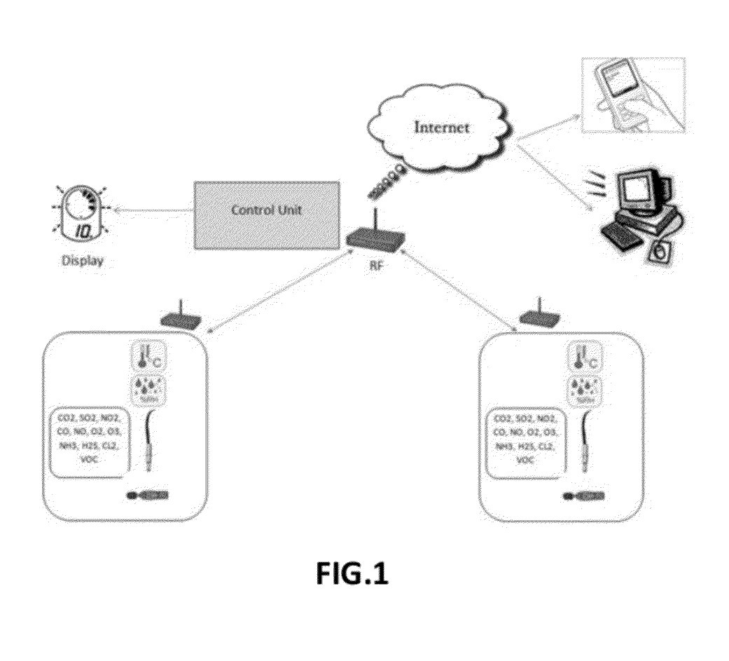

The FIG. 1 represents the data capture and flow of the system across its various constituents. The sensor system is a combination of various sensors put strategically in a well engineered cavity for maximum sensing efficient and accuracy. This information is sent to central controller through the use of Local Radio Frequency (RF). The Radio transceivers used as one specific implementation, but to limited to, are of Nordic Semiconductors with 2.4 GHz ISM band. The typical transmission range of this RF module is about 250 meters in open air for such a transceiver. Such multiple sensors system send their data to the local central control device which aggregates and analysis the data. The local central control system has the ability to store data, control the transmission system and further display the same. The controller has a display system by means of which it can display in one of the current implementation in a 320×240 pixel LCD that is attached to the body of the controller. The displayed values are the current values of the individual sensor values corrected against their calibrated values.

In another display system that was implemented, the display was a large LED display board kept in a busy market corner to be made visible for general public for pollution awareness as well as showing the current pollutants in the environment.

The data from controller is sent back to a central server through a multitude of means viz. WiFi network, GSM network and alike. The data is sent to the central database that is on the TCP/IP network and then from there it was displayed in the browser as an interface to the data for general user on a computer. In another implementation, the data was also made visible to a mobile user through the use of a mobile application on iPhone.

Various methods of analysis were carried out in the real-time sample implementation. In one such means, the data was calibrated on the device and displayed on the LCD or LED board. In another instance, where the LED board was at a distance, it was connected directly to the database server and the sensor values were calibrated and sent directly to the LED display board.

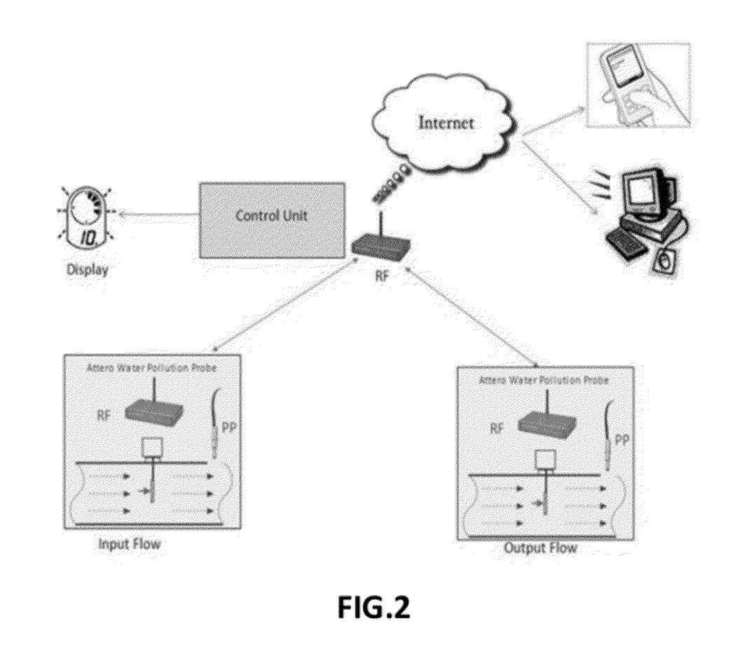

FIG. 2 represents similar setup as described in FIG. 1 was implemented for the real-time water monitoring system. For the water monitoring system two such units were put in place. Where, one at the Input level and other at the output level of water flow system of a sample premises. The results were analyzed as per the input pollutants constituents. Compared to the input, the output was found to contain more pollutants, which is because the chemical process in the recycling plant was generating pollution.

### Calibration

Calibration is done by Non Standard Span Gas Calibration method where span gas is within ±1% of full scale with current source.

As one sample implementation, the following steps have been adopted for the calibration:
1. Connecting communication link to PC USB Port or initiate Wireless Calibration Mode;
2. Uploading any data in memory logs;
3. Ensuring high quality Zero Gas availability i.e. clear air suitably scrubbed. Also ensure a gas of known valid concentration;
4. Apply Zero gas for 10 minutes at 500 sccm;
5. Taking this reading as base value for clean air;
6. Applying span gas for 10 minutes and take reading;
7. Pressing Span Calibration button
8. Restart Zero gas again to cross check;
9. The temperature for calibration is taken at 25 degree Celsius.

### EXAMPLE 1

The Real-time testing was done at Jim Corbett, Uttrakhand, India on Dec. 31 2010. The various pollutant levels have been recorded by the device. The real-time data was recorded for the ambient air.

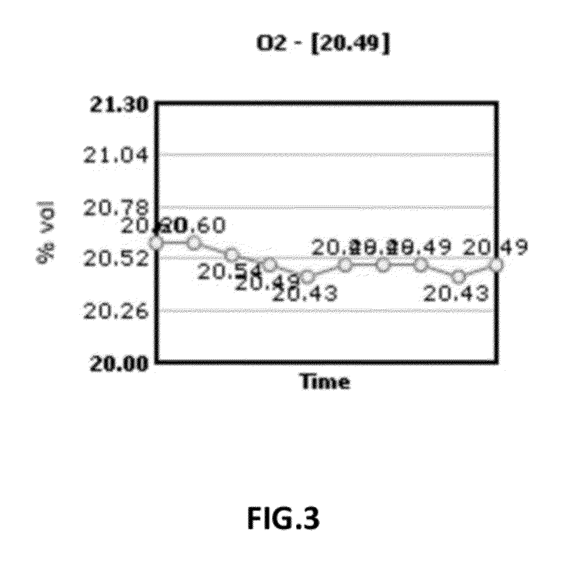

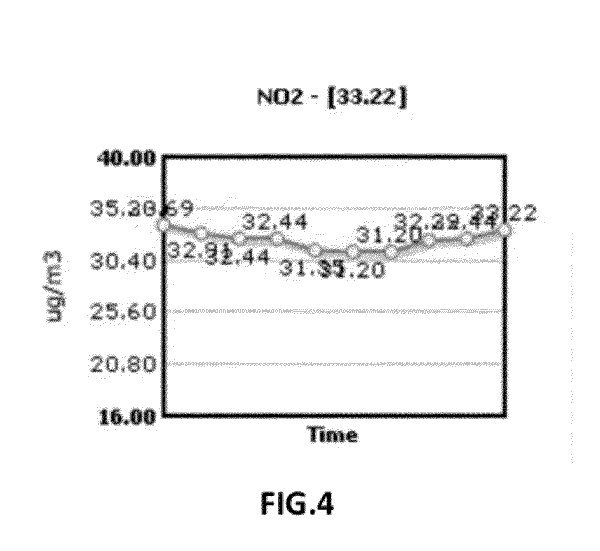

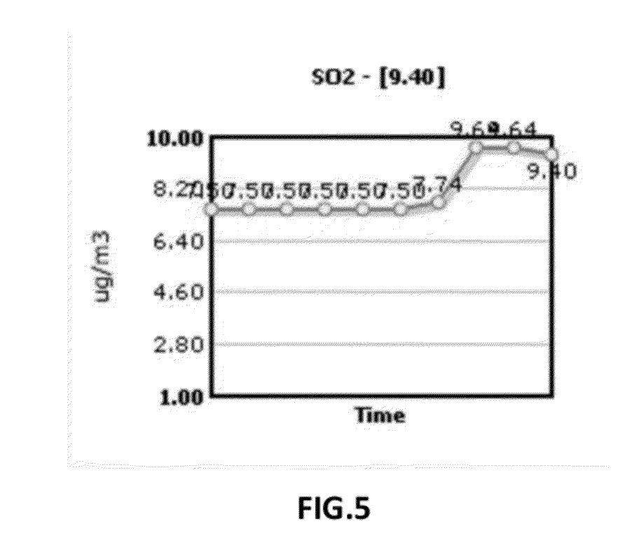

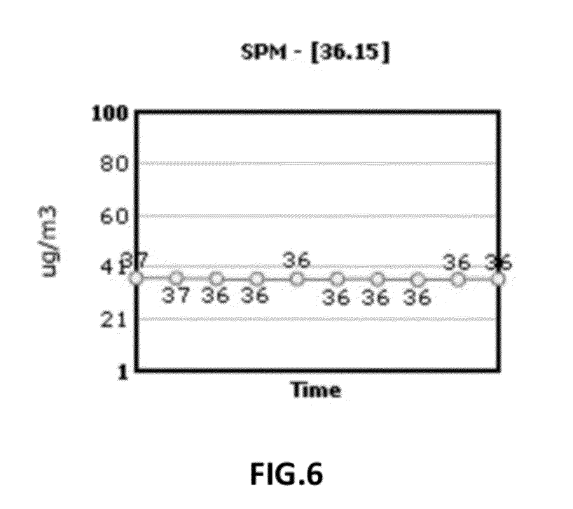

The FIGS. 3, 4, 5 and 6 are the graphical representations of O₂, NO₂, SO₂ and SPM levels on real time basis respectively. The real time graphs have been obtained through the various communication system of this invention where the data on Y-Axis is representing the concentration levels of O₂, NO₂, SO₂ and SPM in micrograms-per meter-cube (μg/m³) with respect to the real-time graph.

It will thus be seen that the objects set forth above, among those made apparent from the preceding description, are efficiently attained and, since certain changes may be made in carrying out the above method and in the construction set forth without departing from the spirit and scope of the invention is intended that all matter contained in the above description and shown in the accompanying drawings shall be interpreted as illustrated and not in a limiting sense.

It is also to be understood that the following claims are intended to cover all of the generic and specific features of the invention herein described and all statements of the scope of the invention in which, as a matter of language might be said to fall there between.

We claim:

1. A system for remote monitoring, measuring and indexing of various pollutants level and environmental details, like weather details or seismic details in a region in real time wherein the said system comprises of:
a. at least one system of single or multiple sensing devices;
b. at least one local central controller;
c. at least one central server;
d. at least one communication network; and
e. one or more display units;
wherein:
the said system of multiple sensing devices transmits data in real time to the said local central controller through the said communication network;
the said local central controller is in communication with the said central server through the said communication network;
the real time data is displayed by the said display units; and the real time pollutant level data is converted into a single, measurable and accessible pollution and/or environmental index number by the said central server.

2. The system for remote monitoring, measuring, and indexing of various pollutants level and environmental details like weather details or seismic details in a region in real time as claimed in claim 1, wherein the said system of multiple sensing devices comprises one or more sensors selected from the group of air pollution sensors, water pollution sensors, gas sensors, soil pollutant sensors, temperature sensing devices, humidity sensing devices, pressure sensors, wind sensing devices, rain measuring devices, radiation detectors, noise detectors, biological pollutant sensors, and other such sensors or combination thereof or third party sensing equipments.

3. The system for remote monitoring, measuring and indexing of various pollutants level and environmental details like weather details or seismic details in a region in real time as claimed in claim 1, wherein the said local central controller of a region collects and analyses the data received from the said sensing devices and transfers the analysed data to central server or communication network.

4. The system for remote monitoring, measuring and indexing of various pollutants level and environmental details like weather details or seismic details in a region in real time as claimed in claim 1, wherein the said central server further analyses the real time data received from one or more local central controllers and generates weather and/or pollution indices of respective regions.

5. The system for remote monitoring, measuring and indexing of various pollutants level and environmental details like weather details or seismic details in a region in real time as claimed in claim 1, wherein the said communication network comprises of wired or wireless connection systems, like multiple Radio Frequency Modes of data communication, Wi-Fi, GSM and alike.

6. The system for remote monitoring, measuring and indexing of various pollutants level and environmental details like weather details or seismic details in a region in real time as claimed in claim 1, wherein the said display unit is selected from the group of in built LCD screen, LCD or LED board, TV screens, mobile device screens including those of mobile phones, tablets and notebooks, digital hoardings, kiosks, Internet browsers on PC and alike.

7. The system for remote monitoring, measuring and indexing of various pollutants level and environmental details like weather details or seismic details in a region in real time as claimed in claim 1, wherein each of the said sensors is further connected to one or more trans receivers through wire or wirelessly.

8. The system for remote monitoring, measuring and indexing of various pollutants level and environmental details like weather details or seismic details in a region in real time as claimed in claims 1 and 7, wherein the trans receiver analyses the real time data received from the said sensor and transmits the real time analysed data to the local central controller or communication network.

9. The system for remote monitoring, measuring and indexing of various pollutants level and environmental details like weather details or seismic details in a region in real time as claimed in claim 1, wherein the said sensing device can be installed in an area like home, hospitals, industrial areas an alike, or on transport means and vehicles.

10. The system for remote monitoring, measuring and indexing of various pollutants level and environmental details like weather details or seismic details in a region in real time as claimed in claims 1 and 9, wherein the said sensing device is enabled with Global Positioning System.

11. A method of remote monitoring, aggregating, analysing and indexing the disparate real time pollutant level data into a single measurable and accessible pollution and/or environmental index data using:
a. at least one system of single or multiple sensing devices;
b. at least one local central controller;
c. at least one central server;
d. at least one communication network; and
e. one or more display units;
wherein:
the said system of multiple sensing devices transmits data in real time to the said local central controller through the said communication network;
the said local central controller is in communication with the said central server through the said communication network;
the real time data is displayed by the said display units; and
the real time pollutant level data is converted into a single, measurable and accessible pollution and/or environmental index number by the said central server.

12. The method of remote monitoring, aggregating, analysing and indexing the disparate pollutant level data into a single measurable and accessible pollution and/or environmental index data as claimed in claim 11, wherein the said disparate pollutant data is aggregated and analysed by the said system of multiple sensing devices; then sent to the said local central controller; then further analysed by the said local central controller; then sent to the said central server further analyses the data received and provides a single measurable and accessible pollution and/or weather index for particular regions; and then displayed by the said display units.

13. The method of remote monitoring, aggregating, analysing and indexing the disparate pollutant level data into a single measurable and accessible pollution and/or environmental index data as claimed in claim 11, wherein the index data is accessible as graphical representations, maps, landscapes, and alike, and/or having colour coding system to present and interpret various levels of pollutants and/or indexes.

14. The method of remote monitoring, aggregating, analysing and indexing the disparate pollutant level data into a single measurable and accessible pollution and/or environmental index data as claimed in claim 11, wherein the index data can be uploaded on world wide web through data transfer technologies selected from the group of FTP, Email, HTTP, AJAX, XML Transfer, TCP/IP, and alike.

15. The method of remote monitoring, aggregating, analysing and indexing the disparate pollutant level data into a single measurable and accessible pollution and/or environmental index data as claimed in claim 11, wherein the data thus generated is stored in local database comprising of one or more of data storage systems from the group of RAM, ROM, all types of Solid State Device, Magnetic Hard Disk, Magnetic Tape and alike; and/or remotely stored in web servers, either as files or as database entries;
and can be reproduced, transferred from one mode to another, and used to generate reports.

16. The method of remote monitoring, aggregating, analysing and indexing the disparate pollutant level data into a single measurable and accessible pollution and/or environmental index data as claimed in claim 11, wherein the said sensing devices raise alarm if tampered with or if the pollutant level increases above maximum limit.

17. The method of remote monitoring, aggregating, analysing and indexing the disparate pollutant level data into a single measurable and accessible pollution and/or environmental index data as claimed in claims 11 and 16, wherein the said system captures images and/or videos of the incidence of violation.

18. The method of remote monitoring, aggregating, analysing and indexing the disparate pollutant level data into a single measurable and accessible pollution and/or environmental index data as claimed in claim 11, wherein said single, measurable and accessible pollution and/or environmental index number indicates consolidated pollution level.
